(19) United States
(12) Patent Application Publication
(10) Pub. No.: US 2009/0150138 A1
(43) Pub. Date: Jun. 11, 2009

(54) Apparatus and method for analyzing circuit

(75) Inventor: Susumu Kobayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,231

(22) Filed: Dec. 5, 2008

(30) Foreign Application Priority Data
Dec. 6, 2007 (JP) 2007-315675

(51) Int. Cl. G06F 17/50

(52) U.S. Cl. 703/14

(57) ABSTRACT

In an aspect of the present invention, a circuit analyzing method includes: generating an analysis object circuit model by connecting a package model as a lumped parameter circuit model of a package, a noise source model as a lumped parameter circuit model of a noise source circuit, a noise-receiving circuit model as a lumped parameter circuit model of a noise-receiving circuit, and a substrate model as a lumped parameter circuit model of a substrate between the noise source circuit and a noise-receiving circuit; and performing a circuit simulation to the analysis object circuit model to calculate a power supply voltage waveform in the noise-receiving circuit.

### INCORPORATION BY REFERENCE

This application claims priority on convention based on Japanese Patent Application (2007-315675). The disclosure thereof is incorporated herein by reference.

### BACKGROUND OF THE INVENTION

1. Field of the Invention

The present invention relates to a method for designing a semiconductor device, and more particularly, to a circuit analyzing method, and a circuit analyzing apparatus that analyze power supply noise in consideration of substrate noise of a semiconductor device to be designed.

2. Description of Related Art

In recent years, along with increase in degree of integration of an LSI (Large Scale Integrated Circuit) and advancement in one-chip formation (System On a Chip: SoC), a semiconductor device loaded with both analog and digital circuits has been widely used. In such a semiconductor device, noise generated in the digital circuit largely influences operation characteristics of the other circuit (e.g., analog circuit). For this reason, to design a semiconductor device, power supply noise influencing operation characteristics of a circuit block is analyzed, and a result of the analysis should be fed back to a layout of an entire circuit.

Also, to analyze the power supply noise, substrate noise transmitted in a silicon substrate should be taken into account. A method of analyzing the substrate noise is described in Japanese Patent Application Publications (JP-P2006-302938A: related art 1, and JP-P2006-236340A: related art 2).

According to a method described in the related art 1, a layout on a silicon substrate is mesh-divided into regions, and an equivalent circuit is formed from resistances and capacitances for each of the regions to generate a circuit model subjected to noise analysis. Also, the related art 2 describes a system for analyzing the substrate noise generated along with a switching operation in a digital circuit.

As described above, an LSI provided with a circuit likely to be influenced by power supply noise (e.g., analog macro) along with a digital circuit has been increasingly demanded. On the other hand, in recent years, a power supply layer is multilayered, and the power supply layer and a substrate functioning as transmission paths constitute a large-scale power supply & substrate network. For this reason, a technique for accurately reducing the power supply & substrate network is required in order to perform a high-speed analysis of power supply noise transmitted in the power supply layer and substrate.

A noise analyzer described in the related art 1 has an effect of shortening an analysis time because the number of substrate noise sources is limited to perform the noise analysis. However, the layout of the silicon substrate is mesh-divided into regions, and a circuit model for every region is used to analyze the substrate noise. For this reason, if a size of an analysis target circuit is large, or a detailed noise analysis is performed, the number of circuit models to be analyzed is enormous, so that the analysis time is increased.

On the other hand, in a substrate noise analysis system described in the related art 2, a switching operation of the digital circuit is modeled, and a circuit model only including a passive circuit element is used to perform the noise analysis. This circuit model only includes small numbers of circuit elements and passive circuit elements, and therefore a high-speed simulation can be achieved. However, the analysis target circuit model described in the related art 2 includes a package model having RLC mesh, and therefore if the number of meshes is increased, an amount of calculation for the analysis is increased, and therefore an analysis time is increased.

### SUMMARY

In an aspect of the present invention, a circuit analyzing method includes: generating an analysis object circuit model by connecting a package model as a lumped parameter circuit model of a package, a noise source model as a lumped parameter circuit model of a noise source circuit, a noise-receiving circuit model as a lumped parameter circuit model of a noise-receiving circuit, and a substrate model as a lumped parameter circuit model of a substrate between the noise source circuit and a noise-receiving circuit; and performing a circuit simulation to the analysis object circuit model to calculate a power supply voltage waveform in the noise-receiving circuit.

In another aspect of the present invention, a circuit analyzing apparatus includes: a storage section configured to store a package model as a lumped parameter circuit model of a package, a noise source model as a lumped parameter circuit model of a noise source circuit, a noise-receiving circuit model as a lumped parameter circuit model of a noise-receiving circuit, and a substrate model as a lumped parameter circuit model of a substrate between the noise source circuit and a noise-receiving circuit; and a noise analyzing section configured connect the package model, the noise source model, the noise-receiving circuit model, and the substrate model to generate an analysis object circuit model.

According to a circuit analyzing method, a circuit analysis program, and a circuit analyzing apparatus of the present invention, a time for analyzing power supply noise in consideration of substrate noise can be shortened.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a diagram illustrating a configuration of a circuit analyzing apparatus according to the present invention;

FIG. 2 is a block diagram illustrating a part of the configuration of the circuit analyzing apparatus according to the present invention;

FIG. 3 is a block diagram illustrating a part of the configuration of the circuit analyzing apparatus according to the present invention;

FIG. 4 is a block diagram illustrating a part of the configuration of the circuit analyzing apparatus according to the present invention;

FIG. 5 is a block diagram illustrating a part of the configuration of the circuit analyzing apparatus according to the present invention;

FIG. 6 is a diagram illustrating an example of an analysis target circuit model associated with the present invention;

FIG. 7 is a flowchart illustrating an example of operations of the circuit analyzing apparatus according to the present invention;

FIG. 8 is a diagram illustrating an example of the analysis target circuit model associated with the present invention; and

FIG. 9 is a diagram illustrating an example of the analysis target circuit model associated with the present invention.

### DESCRIPTION OF THE PREFERRED EMBODIMENTS

Hereinafter, a circuit analyzing apparatus according to the present invention will be described in detail with reference to the attached drawings.

The circuit analyzing apparatus analyzes power supply noise under consideration of substrate noise propagating through a silicon substrate of a semiconductor device to be designed, and changes a layout of the semiconductor device based on a result of the analysis. The circuit analyzing apparatus uses a lumped constant circuit model for each of a package, a substrate (including power supply lines), a noise source circuit, and a noise-receiving circuit to analyze the power supply noise in the noise-receiving circuit.

### (Configuration)

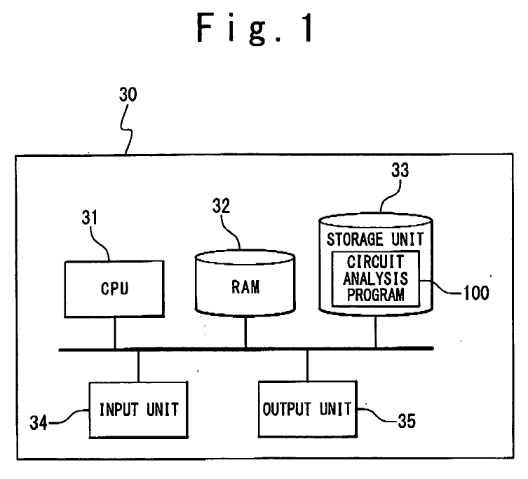

Referring to FIGS. 1 to 5, a configuration of the circuit analyzing apparatus 30 according to an embodiment of the present invention will be described. Referring to FIG. 1, the circuit analyzing apparatus 30 according to the present embodiment of the present invention is a computer including a CPU 31, a RAM 32, a storage unit 33, an input unit 34, and an output unit 35, which are connected to each other through a bus 36. The storage unit 33 is such as a hard disk and a memory. Also, the input unit 34 is such as a keyboard and mouse, and outputs various types of data to the CPU 31 and the storage unit 33 through an operation of by a user. The output unit 35 is such as a monitor and a printer, and outputs a result of a circuit analysis in a format visible to the user from the CPU 31.

The CPU 31 executes a circuit analysis program 100 stored in the storage unit 33 in response to an instruction from the input unit 34 to analyze noise of the analysis target circuit, or examine operation characteristics of a circuit block on the analysis target circuit. At this time, various types of data and a program from the storage unit 33 are temporarily stored in the RAM 32, and the CPU 31 uses the data stored in the RAM 32 to execute various types of processes. The CPU 31 executes the circuit analysis program 100 to provide respective functions of a circuit model generating section, a circuit analyzing section, and a design change section. The circuit model generating section, the circuit analyzing section, and the design changing section are described below in detail.

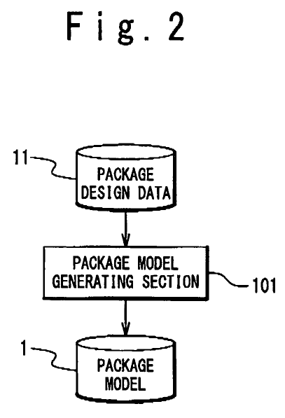

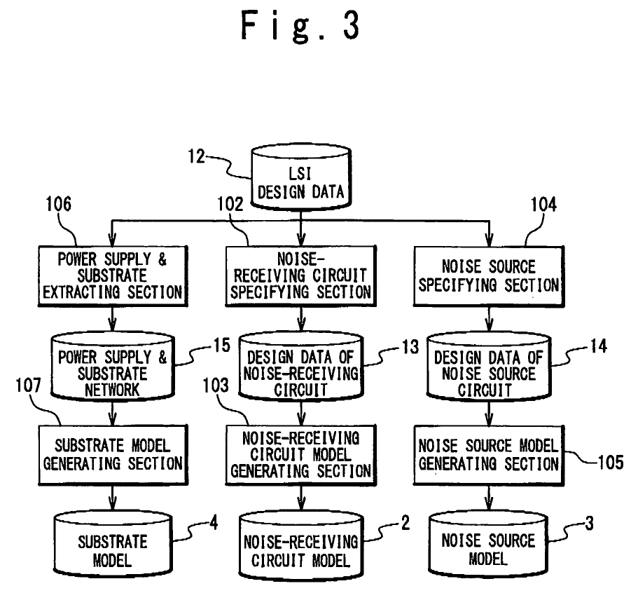

The circuit model generating section includes a package model generating section 101, a noise-receiving circuit specifying section 102, a noise-receiving circuit model generating section 103, a noise source specifying section 104, a noise source model generating section 105, a power supply & substrate extracting section 106, and a substrate model generating section 107, which are illustrated in FIGS. 2 and 3.

Referring to FIG. 2, the package model generating section 101 generates a package model 1 on the basis of package design data 11 stored in the storage unit 33. It should be noted that the package design data 11 includes a layout data and a device parameter of a package, which are set for each of phases such as system design and a floor plan. The package model generating section 101 performs a circuit simulation on the basis of the package design data to derive input/output characteristics of the package. The package model generating section 101 calculates a resistance (R), an inductance (L), and a capacitance (C) of the package on the basis of the input/output characteristics to generate a lumped constant circuit model (the package model 1) for the package. The generated package model 1 is stored in the storage unit 33. The package model 1 is generated by using a lumped constant circuit with no position data. However, the package model 1 may be generated by diversifying RLC (arbitrarily setting the numbers of RLCs) to include the position data, depending on a design condition. It should be noted that the package model 1 is preferably based on the lumped constant circuit in order to shorten an analysis time for a noise analysis to be described later.

Referring to FIG. 3, the noise-receiving circuit specifying section 102 derives a circuit block sensitive to noise (e.g., analog macro, hereinafter to be referred to as a noise-receiving circuit) on the basis of an LSI design data 12. The LSI design data 12 includes a layout data and device parameters of an analysis target circuit, which are set for each of phases as after system design and floor plan, and has a data format such as an LEF (layout exchange format) or DEF (design exchange format). For example, the noise-receiving circuit specifying section 102 performs a circuit simulation to estimate sensitivity to power supply noise for each circuit block on the basis of the LSI design data 12. The noise-receiving circuit specifying section 102 specifies a circuit block having the estimated sensitivity higher than a predetermined threshold as the noise-receiving circuit. The noise-receiving circuit specifying section 102 records the layout data, a device parameter, and the like associated with the specified noise-receiving circuit in the storage unit 33 as a noise-receiving circuit design data 13. It should be noted that an existing analysis tool may be used for the noise-receiving circuit specifying section 102.

The noise-receiving circuit model generating section 103 uses the noise-receiving circuit design data 13 to perform a circuit simulation, and thereby derives input/output characteristics of the noise-receiving circuit. The noise-receiving circuit model generating section 103 calculates a resistance (R), an inductance (L), and a capacitance (C) of the noise-receiving circuit on the basis of the input/output characteristics to generate a lumped constant circuit model (a noise-receiving circuit model 2) for the noise-receiving circuit. The noise-receiving circuit model 2 is only required to include at least one lumped constant element among R, L, and C, and may be configured to use of, for example, one capacitance element. The generated noise-receiving circuit model 2 is stored in the storage unit 33.

The noise source specifying section 104 specifies a circuit block generating power supply noise equal to or higher than a predetermined threshold, as a noise source circuit on the basis of the LSI design data 12. For example, the noise source specifying section 104 specifies as the noise source circuit, a circuit block having a node at which a power supply voltage variation is large, or a circuit block of which a power supply current is large. Also, at an initial stage of design, the noise source specifying section 104 can specify the noise source circuit on the basis of a power consumption estimation value, a gate scale, a clock signal frequency, a floor plan, or the like. Further, a whole of digital circuits in the analysis target circuit, or a whole of the analysis target circuit (a chip) may be specified as the noise source circuit. The noise source specifying section 104 records a layout data and device parameters associated with the specified noise source circuit in the storage unit 33 as a noise source design data 14. It should be noted that an existing analysis tool may be used for the noise source specifying section 104.

The noise source model generating section 105 uses the noise source design data 14 to perform a circuit simulation, and thereby derives the input/output characteristics of the noise source circuit. The noise source model generating section 105 calculates a resistance (R), an inductance (L), a capacitance (C), and a current source on the basis of the input/output characteristics to generate a lumped constant circuit model (a noise source model 3) for the noise source circuit. The noise source model 3 is only required to include at least one lumped constant element among R, L, and C, and may be configured to use of, for example, one capacitance element and one current source element. The generated noise source model 3 is stored in the storage unit 33. The noise source specifying section 104 records the layout data and device parameters associated with the specified noise source circuit in the storage unit 33 as the noise source design data 14.

The power supply & substrate extracting section 106 extracts a parasitic element group (a parasitic resistance, a parasitic inductance, and a parasitic capacitance) in a power supply line and a silicon substrate of the analysis target circuit on the basis of the LSI design data 12, and outputs it as a power supply & substrate network 15 (an RLC network). Specifically, the power supply & substrate extracting section 106 divides the power supply line in meshes of a predetermined mesh size, extracts the parasitic elements (a parasitic resistance (R) and a parasitic inductance (L)) of the power supply line for each of meshes, and connects the extracted parasitic elements to generate a power supply network. It should be noted that, if there are a plurality of power supply systems, the power supply network is generated for each of the power supply systems. Also, the power supply & substrate extracting section 106 divides the substrate into meshes of a predetermined mesh size, extracts a parasitic element (the parasitic resistance (R)) for each of the meshes, and connects the extracted parasitic elements to generate a substrate network. Then, the power supply & substrate extracting section 106 extracts, on the basis of the LSI design data 12, a parasitic capacitance (C) between the power supply network and the substrate network, or between different power supply networks if there are a plurality of the power supply systems. The power supply & substrate extracting section 106 connects the generated power supply network and the substrate network to each other through the extracted parasitic capacitance (C), and outputs the connected configuration as the power supply & substrate network 15. This allows a parasitic element parameter including position data to be extracted as the power supply & substrate network 15. The power supply & substrate extracting section 106 records the extracted power supply & substrate networks in the storage unit 33. It should be noted that an existing parasitic element extracting tool may be used for the power supply & substrate extracting section 106.

The substrate model generating section 107 uses the power supply & substrate network 15 to perform a circuit simulation, and thereby generates a lumped constant circuit model (a substrate model 4) for the power supply line and the substrate. Specifically, the substrate model generating section 107 uses the power supply & substrate network 15 between the specified noise source circuit and the noise-receiving circuit to perform the circuit simulation, and thereby derives input/output characteristics between the noise source circuit and the noise-receiving circuit. The substrate model generating section 107 generates the lumped constant circuit model on the basis of the input/output characteristics. The substrate model generating section 107 records the generated lumped constant circuit model in the storage unit 33 as the substrate model 4. The substrate model 4 may be a circuit model having only one resistive element.

As described above, the substrate model generating section 107 derives the substrate model 4 (e.g., resistance) on the basis of the circuit simulation using the power supply & substrate network 15 including the position data. For this reason, the substrate model 4 has the element parameters in which the position data is taken into account, although it is a lumped constant circuit model. It should be noted that regarding the substrate model 4, the modeling may be performed by diversifying RLC (arbitrarily setting the numbers of RLCs) depending on a design condition. However, the substrate model 4 is preferably based on the lumped constant circuit in order to shorten the analysis time for the noise analysis to be described later.

As described above, the circuit analyzing apparatus 30 according to the present invention can model each of the package, the noise source circuit, the noise-receiving circuit, the power supply, and the substrate by using the lumped constant circuit.

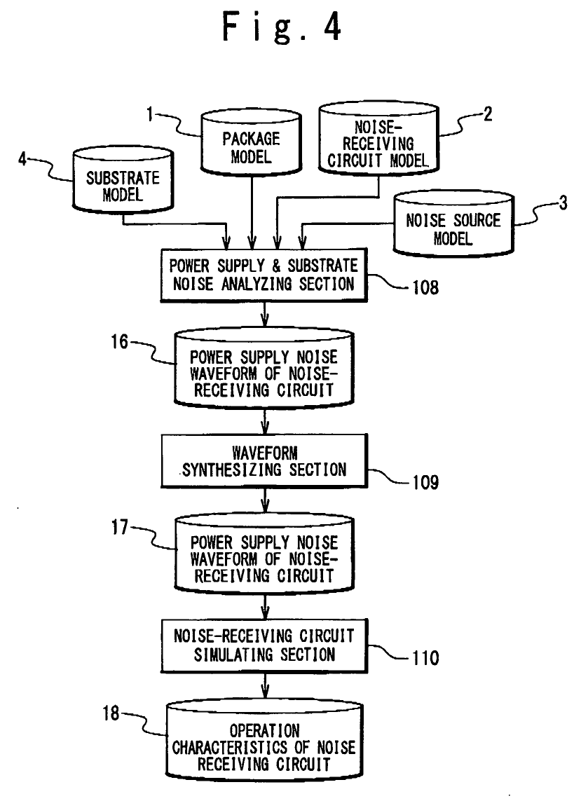

As shown in FIG. 4, the circuit analyzing section includes a power supply & substrate noise analyzing section 108, a waveform synthesizing section 109 (a power supply voltage synthesizing section), and a noise-receiving circuit simulation section 110.

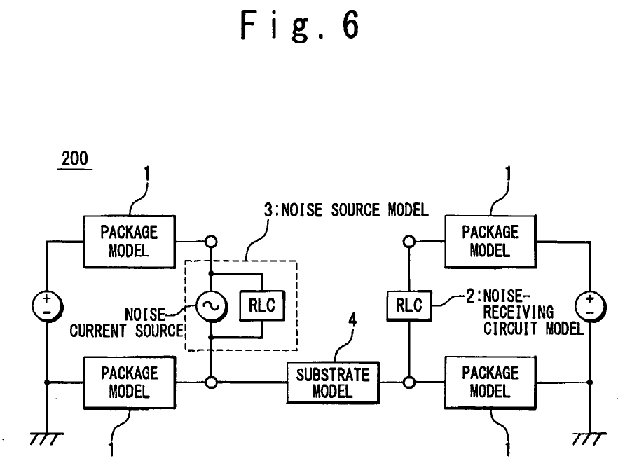

Referring to FIG. 4, the power supply & substrate noise analyzing section 108 is connected with the package model 1, the noise-receiving circuit model 2, the noise source model 3, and the substrate model 4 to generate an analysis target circuit model 200. FIG. 6 is a diagram showing an example of the analysis target circuit model 200 of a circuit in which a substrate and a power supply (VDD) are separated from each other.

The power supply & substrate noise analyzing section 108 performs a circuit simulation of the analysis target circuit model 200 to calculate a power supply voltage waveform in the noise-receiving circuit. Specifically, the power supply & substrate noise analyzing section 108 simulates an operation of the noise-receiving circuit on the basis of a circuit connection data and electrical characteristics of elements in the circuit, which are included in the analysis target circuit model 200, to calculate a power supply voltage waveform 16 (a power supply noise waveform) in the noise-receiving circuit. At this time, the power supply & substrate noise analyzing section 108 does not calculate a transmission loss characteristic as distributed constants, but performs the circuit simulation on the basis of a loss characteristic expression defined with a simple parameter (lumped constants). The calculated power supply noise waveform 16 is recorded in the storage unit 33. It should be noted that an existing analysis tool (e.g., SPICE) may be preferably used as the power supply & substrate noise analyzing section 108.

If there are a plurality of noise source circuits specified by the noise source specifying section 104, the power supply & substrate noise analyzing section 108 performs the circuit simulation of the analysis target circuit model 200 generated for each of the noise source circuits, and calculates the power supply voltage waveform 16 in the noise-receiving circuit for each of the noise source circuits. The waveform synthesizing section 109 synthesizes the power supply voltage waveforms 16 calculated for the respective noise source circuits, into a power supply voltage waveform 17 (a power supply noise waveform) in which power supply noises from all of the specified noise source circuits to the noise-receiving circuit are synthesized.

The noise-receiving circuit simulation section 110 uses the power supply voltage waveform 17 outputted from the waveform synthesizing section 109 to perform a simulation of the noise-receiving circuit. On the basis of this simulation, the noise-receiving circuit simulation section 110 calculates operation characteristics 18 such as an output voltage, a response characteristic, and a power consumption, of the noise-receiving circuit under influence of the power supply noises from all of the specified noise source circuits, and records them in the storage unit 33.

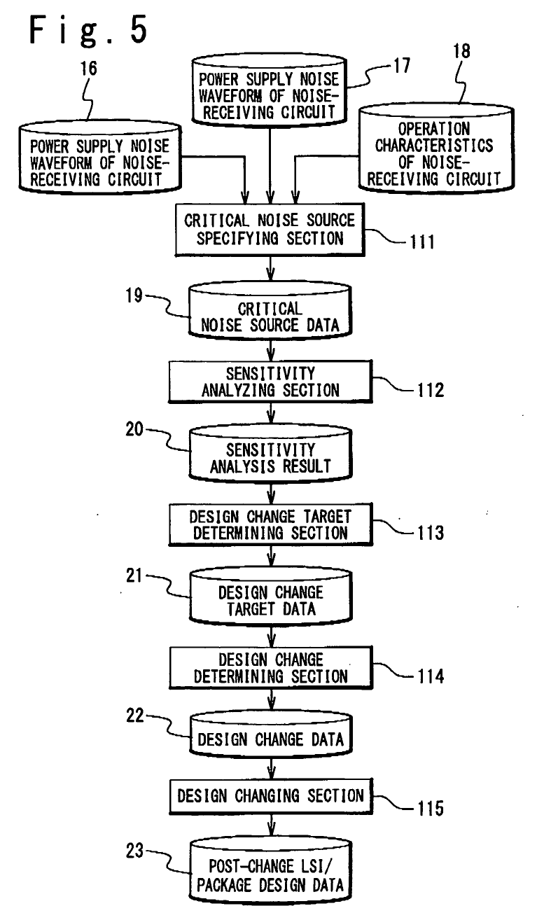

The design changing section includes a critical noise source specifying section 111, a sensitivity analyzing section 112, a design change target determining section 113, a design change determining section 114, and a design changing section 115, which are shown in FIG. 5.

Referring to FIG. 5, the critical noise source specifying section 111 determines whether or not there is any problem in the operation characteristics 18, and if there is any problem, specifies a noise source circuit causing a defective operation. In the storage unit 33, operation characteristics in a normal operation are recorded as reference operation characteristics for each circuit block. The critical noise source specifying section 111 determines whether or not the operation characteristics 18 meet the reference operation characteristics. For example, if an output voltage range is set as the reference operation characteristics, and an output voltage indicated by the operation characteristics 18 is in the output voltage range, the noise-receiving circuit is determined to be in the normal operation state, whereas it is out of the range, the noise-receiving circuit is determined to be in a defective operation state.

If determining that the noise-receiving circuit is defective in operation, the critical noise source specifying section 111 refers to the power supply voltage waveform 17 to specify a noise source circuit causing the defective operation. For example, the critical noise source specifying section 111 first specifies a noise frequency causing the problem from the operation characteristics 18. Then, the critical noise source specifying section 111 refers to the power supply voltage waveforms 16 and 17 to specify the power supply voltage waveform 16 that is included in the power supply voltage waveform 17 and largely influences the amplitude of noise having the specified noise frequency. Subsequently, the critical noise source specifying section 111 specifies a noise source circuit corresponding to the specified power supply voltage waveform 16 as a critical noise source circuit. A design data on the noise source circuit (a circuit block) specified as the critical noise source circuit is recorded in the storage unit 33 as the critical noise source data 19.

Alternatively, in the development stage of macros (e.g., analog macros), operations of each of the macros may be characterized to integrate values of power supply noises (power supply noise tolerances) not causing the defective operation into a library for every macro and every frequency and store the library in the storage unit 33. In this case, the noise-receiving circuit simulation section 110 is not necessary, and the critical noise source specifying section 111 compares a power supply noise tolerance corresponding to the specified noise-receiving circuit with the power supply voltage waveform 17 to determine whether or not the noise-receiving circuit is defective in operation. Also, the critical noise source specifying section 111 compares the power supply noise tolerance for each frequency with the power supply voltage waveform 17 to specify the noise frequency causing the problem.

The sensitivity analyzing section 112 examines a variation of power supply noise (the power supply voltage waveform 16 or 17) when lumped constants of each of the package model 1, the noise-receiving circuit model 2, the noise source model 3, and the substrate model 4 are changed in the analysis target circuit model 200 including the specified critical noise source circuit. The sensitivity analyzing section 112 stores a relationship among the changed lumped constants (RLC), the circuit model with the lumped constants changed, and a variation amount of the power supply voltage (power supply noise) in the storage unit 33 as a sensitivity analysis result 20. The design change determining section 114 or a designer refers to the sensitivity analysis result 20, and can determine parameters (circuit elements and lumped constant elements) that should be changed to suppress the power supply noise.

The design change target determining section 113 specifies the circuit model effective to suppression of the power supply noise on the basis of the sensitivity analysis result 20 in the analysis target circuit model 200. For example, the design change target determining section 113 refers to the sensitivity analysis result 20 to determine the circuit model (the package model 1, the noise-receiving circuit model 2, the noise source model 3, and the substrate model 4) in which the lumped constants are to be changed, and types the lumped constants (any of RLC) and variation amounts of the lumped constants to be changed so as to meet a desired power supply noise value. Then, the design change target determining section 113 outputs them as a design change target data 21.

The design change determining section 114 determines design change data 22 corresponding to the design change target data 21. In other words, the design change determining section 114 determines the design change data of the change target circuit element (a package, a substrate, or macro) determined to be specifically made by the design change target determining section 113. For example, if the design change target data 21 includes a data of “a resistance value (R) in the package model is increased by a certain value”, the design change determining section 114 determines the change as “the number of package pins is increased such that the resistance value (R) in the package takes a value indicated by the design change target data 21”. At this time, a data including a data for changing the number of package pins and an increase amount of the pins is outputted as the design change data 22.

Preferably, the design change determining section 114 refers to a design change database storing relationship of changed values of lumped constants and the design change contents to determine the design change data 22 corresponding to the design change target data 21. In this case, in the storage unit 33, the circuit elements (a package, a substrate, and a macro), the lumped constant types (any of RLC), and variation amounts of the lumped constants are stored in relation to the design change contents in advance as the design change database. For example, the package as the circuit element, R as the lumped constant, the variation amount (a predetermined increase amount), the design change (an increase amount of the pins for increase in resistance value) are recorded in the design change database. If the design change target data 21 includes the data of “a resistance value (R) in the package model is increased by a certain value”, the design change determining section 114 calculates an increase amount of the package pins on the basis of the design change target data 21.

Examples of the design changes include “the number of package pins is increased”, “a decoupling capacitance is increased (capacitance of the noise source circuit or/and the noise-receiving circuit is increased)”, “a structure of the substrate is changed”, “a layout of the noise source circuit or/and the noise-receiving circuit is changed”, and the like.

The design changing section 115 changes the package design data 11 or/and the LSI design data 12 on the basis of the determined design change data 22. The changed package design data 11 or/and the LSI design data 12 are recorded in the storage unit 33 as post-change LSI/package design data 23.

The configuration as described above allows the circuit analyzing apparatus 30 according to the present invention to analyze the influence of the power supply noise in consideration of the substrate noise, and to correct the package design data 11 or/and LSI design data 12 so as to prevent the power supply noise causing the defective operation from being supplied to a circuit block.

According to the present invention, the lumped constant circuit model is used to perform noise analysis, and therefore a simulation time can be shortened. Also, the lumped circuit constants are used as the data for changing the design data, and therefore the number of parameters for determining changes is small. For this reason, a condition for determining the design change can be simplified, and therefore a designer can easily determine the change. Further, a design content can be determined by only preparing the design change database storing relationship among the circuit elements (circuit models), the lumped constants, and the design changes, and therefore the determination of the design change can be easily automated.

Also, in the circuit analyzing apparatus 30 according to the present invention, the power supply voltage (power supply noise) of the noise-receiving circuit is calculated for each of the noise source circuits. Therefore, the noise source circuit largely influencing the operation characteristics of the noise-receiving circuit can be easily specified. For this reason, the noise source circuit causing the defective operation can be easily specified.

Further, in the circuit analyzing apparatus 30 according to the present invention, parasitic element networks for the power supply and substrate (the power supply & substrate network 15) are extracted, and the substrate model 4 is generated by the circuit simulation. At this time, the circuit simulation is performed between the two points, i.e., the noise source circuit and the noise-receiving circuit, on the substrate network 15. For this reason, the substrate model 4 comes to a model including the resistance value (R) in consideration of a position data (layout positions) of the noise source circuit and the noise-receiving circuit, although it is the lumped constant circuit model. Accordingly, the analysis target circuit model 200 associated with the present invention is a model closer to an actual circuit as compared with a conventional technique, and therefore a highly accurate noise analysis can be achieved.

It should be noted that a portion of the circuit analysis program, which provides the circuit model generating section and the design changing section, may not be loaded on the above-described circuit analyzing apparatus, but may be loaded on another computer to be executed. In this case, a data generated in the circuit model generating section and the design changing section is stored in a storage unit belonging to the computer.

### (Operation)

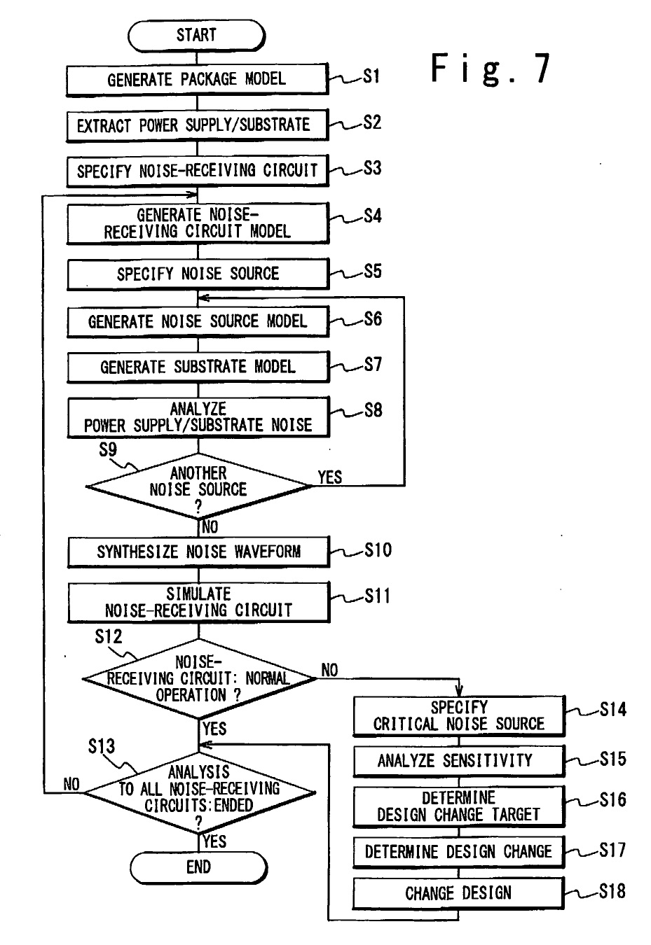

FIG. 7 is a flowchart showing a circuit analyzing method (a noise analysis method and a design data changing method) by the circuit analyzing apparatus of the present invention. Referring to FIG. 7, the circuit analyzing method according to the present invention will be described in detail. Here, a circuit analysis after floor plan design is described as an example.

First, the package model generating section 101 generates the package model 1 on the basis of the package design data 11 obtained through the floor plan design (Step S1). It should be noted that if there is design data on a board, the package model generating section 101 may also generate a lumped constant circuit model of the board together with the package model 1. The power supply & substrate extracting section 106 extracts the power supply & substrate network 15 on the basis of the LSI design data 12 obtained through the floor plan design (Step S2). Then, the noise-receiving circuit specifying section 102 specifies a circuit block sensitive to noise such as an analog macro as a noise-receiving circuit (Step S3). For example, an analog macro such as a PLL (Phase Locked Loop) circuit or a DA (Digital-to-Analog) converter is specified as the noise-receiving circuit. The number of noise-receiving circuits to be specified in this step may be one or more.

The noise-receiving circuit model generating section 103 generates the noise-receiving circuit model 2 on the basis of the design data 13 of the noise-receiving circuit specified at the Step S3 (Step S4). If there are a plurality of noise-receiving circuits specified at the Step S3, the noise-receiving circuit model generating section 103 selects one from the plurality of noise-receiving circuits to generate the noise-receiving circuit model 2 of the selected noise-receiving circuit. Subsequently, the selected noise-receiving circuit is subjected to a process at Steps S4 to S18, and power supply noise for the noise-receiving circuit is analyzed.

The noise source specifying section 104 specifies a circuit block generating large power supply noise as a noise source circuit (Step S5). The number of noise source circuits to be specified in this step may be one or more. The noise source model generating section 105 generates the noise source model 3 on the basis of the design data 14 of the noise source circuit specified at the Step S5 (Step S6). If there are a plurality of noise source circuits specified at the Step S5, the noise source model generating section 105 selects one from the plurality of specified noise source circuits to generate the noise source model 3 of the selected noise source circuit. Subsequently, the selected noise source circuit is subjected to a process at the Steps S6 to S9, and thus power supply noise due to the noise source circuit is analyzed.

After the noise-receiving circuit model 2 and the noise source model 3 are generated, the substrate model generating section 107 uses the power supply & substrate network 15 between two points, i.e., the noise-receiving circuit and the noise source circuit, to generate the substrate model 4 (Step S7).

The power supply & substrate noise analyzing section 108 analyzes the power supply noise in the noise-receiving circuit selected at the Step S4. At this step, the power supply & substrate noise analyzing section 108 uses the package model 1, the noise-receiving circuit model 2 selected at the Step S4, the noise source model 3 selected at the Step S6, and the substrate model 4 to generate the analysis target circuit model 200. The power supply & substrate noise analyzing section 108 uses the generated analysis target circuit model 200 to perform the circuit simulation, and thereby calculates a power supply voltage waveform in the noise-receiving circuit. Thus, the power supply voltage waveform of the noise-receiving circuit influenced by the power supply noise from the selected noise source circuit can be calculated.

If there remains any noise source circuit not yet having been analyzed among the noise source circuits specified at the Step 35, the flow returns to the Step S6 (Yes in Step S9). By performing the process at the Steps S6 to S8 as described above to all of the specified noise source circuits, a power supply voltage waveform (power supply noise) due to each of the noise source circuits in the noise-receiving circuit can be analyzed.

After the power supply noises are analyzed for all of the noise source circuits specified at the Step S5, all of the power supply noise waveforms 16 are synthesized by the waveform synthesizing section 109, and a synthetic waveform is outputted as the power supply noise waveform 17 of the noise-receiving circuit (No at the Step S9 and Step S10). Thus, the power supply noise in the noise-receiving circuit can be calculated, in which influence of all of the noise source circuits is taken into account.

The noise-receiving circuit simulation section 110 uses the power supply noise waveform 17 to perform the circuit simulation of the noise-receiving circuit model 2, and thereby calculates the operation characteristics 18 of the noise-receiving circuit under the influence of the power supply noise (Step S11). The critical noise source specifying section 111 refers to the operation characteristics 18 of the noise-receiving circuit to determine whether or not the noise-receiving circuit is in the normal operation state under the influence of the power supply noise (Step S12). If the noise-receiving circuit is in the normal operation state, and the analyses of all of the noise-receiving circuits specified at the Step S3 is not completed, the flow returns to the process the Step S4 (Yes at the Step S12, and No at the Step S13). At the Step S4, one is selected from the noise-receiving circuits not yet analyzed, and the selected noise-receiving circuit is subjected to the noise analysis process in the same manner as above. On the other hand, if all of the specified noise-receiving circuits are in the normal operation state, the circuit analyzing apparatus 30 completes the noise analysis process (Yes at the Step S12, and Yes at the Step S13).

It should be noted that if a power supply noise tolerance is set for the noise-receiving circuit, the process at the Step S11 may be omitted. In this case, the critical noise source specifying section 111 determines on the basis of the power supply noise waveform 17 and the power supply noise tolerance, whether or not the noise-receiving circuit is in the normal operation state. If determining that the noise-receiving circuit is not in the normal operation state, the critical noise source specifying section 111 specifies the noise source circuit causing a defective operation as a critical noise source circuit (Step S14). At this step, a noise frequency causing the defective operation is specified for every noise frequency, and the power supply noise waveform 16 largely influencing the amplitude of noise with the noise frequency is specified. The noise source circuit corresponding to the specified power supply noise waveform 16 is set as the critical noise source circuit. It should be noted that if the number of the noise source circuits specified at the Step S5 is one, the process at the Step S14 is omitted.

The sensitivity analyzing section 112 analyzes a noise suppressing effect by a component (a lumped constant element) of the analysis target circuit model 200 by using the noise source model 3 of the critical noise source circuit specified at the Step S14 (Step S15). At this step, a value of a lumped constant element in each of the circuit models constituting the analysis target circuit model 200 is varied to calculate a variation value of the power supply voltage in the noise-receiving circuit as the sensitivity analysis result 20.

The design change target determining section 113 specifies circuit elements effective in suppressing the noise among the circuit elements (the package model 1, the noise-receiving circuit model 2, the noise source model 3, and the substrate model 4) in the analysis target circuit model on the basis of the sensitivity analysis result 20 (Step S16).

The design change determining section 114 determines a specific design change for changing a lumped constant of the element (a circuit model) specified at the Step S16 (Step S17). The design change determining section 114 determines a change for layout of the circuit element indicated by the design change target data 21.

The design changing section 115 uses the data 22 of the design change determined at the Step S17 to change the package design data 11 or/and LSI design data 11 (Step S18). The circuit analyzing apparatus 30 may repeat the re-generation and noise analysis of the analysis target circuit model 200 in the same manner as described above on the basis of the changed design data until the noise is sufficiently suppressed. For example, the circuit analyzing apparatus 30 changes layout positions of the noise source circuit and the noise-receiving circuit on the basis of the design change data 22, and performs the circuit simulation on the power supply & substrate network 15 of the analysis target circuit (LSI) to re-generate the substrate model 4. Then, the circuit analyzing apparatus 30 repeats a procedure of observing whether or not the power supply noise waveform outputted from the power supply & substrate noise analyzing section 108 is sufficiently suppressed. This completes the noise analysis and design change for the selected noise-receiving circuit.

If the design change is completed and the analysis of all of the noise-receiving circuits specified at the Step S3 is not yet completed, the flow returns to the Step S4 (No at the Step S13). At the Step S4, one is selected from noise-receiving circuits not having been analyzed, and the selected noise-receiving circuit is subjected to the noise analysis and the design change process in the same manner as described above. On the other hand, if the noise analyses and the design changes of all of the specified noise-receiving circuits are completed, the circuit analyzing apparatus 30 completes the noise analysis process (Yes at the Step S13).

As described above, the circuit analyzing apparatus 30 according to the present invention analyzes the power supply noise of each of the noise source circuits for the selected noise-receiving circuits, and therefore easily specifies the noise source circuit largely influencing the operation characteristics of the noise-receiving circuit. Also, the waveform synthesizing section 109 calculates the synthesis of the power supply noises from all of the noise source circuits, which are used to simulate the operation characteristics of the noise-receiving circuits, and therefore influence of the noise on analog macro, which is sensitive to the noise, can be accurately derived.

Further, in the above-described example, the analysis target circuit model 200 is generated on the basis of the design data after floor plan. However, the present invention is not limited to this. In the noise analysis after system design, the analysis target circuit model 200 is generated on the basis of the package data 11 or LSI design data 12 set upon the system design. As described above, in the present invention, the analysis target circuit model is derived through the circuit simulation based on the design data depending on each of the phases such as system design and the floor plan. For this reason, the power supply noise analysis and the design change taking the power supply noise into account can be made from an initial stage of development.

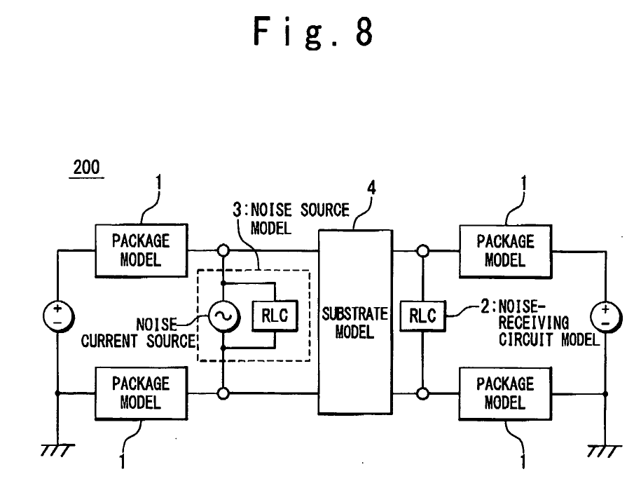

As described above, the embodiment of the present invention has been described in detail. However, the present invention is not limited to a specific configuration in the above embodiments, and any modification without departing from the scope of the present invention is included in the present invention. The analysis target model 200 associated with the present invention may be a circuit model with a power supply separated configuration as shown in FIG. 6, or a circuit model without the power supply separated configuration as shown in FIG. 8, and it should be appreciated that the analysis target circuit model 200 depends on a configuration of a analysis target circuit.

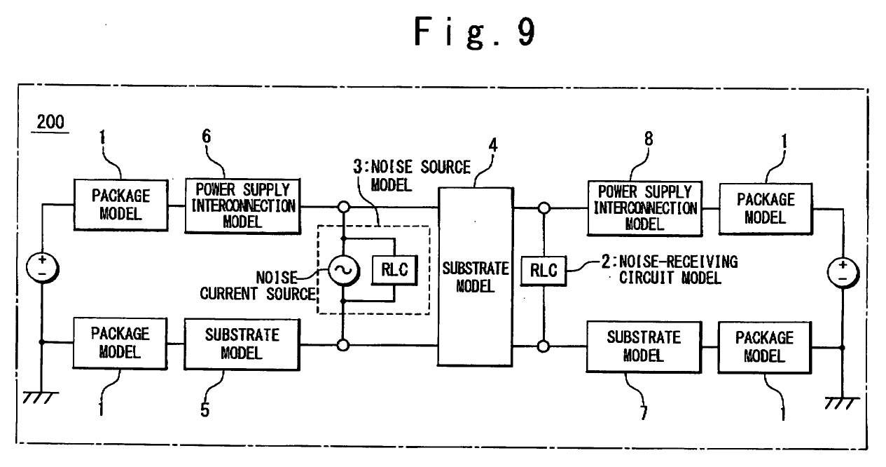

In the analysis target circuit model 200 of the present embodiment, only the substrate model 4 between the noise source circuit and the noise-receiving circuit is used as a substrate model (a power supply model). However, lumped constant circuit models of the power supply line and the silicon substrate influencing the input/output characteristics of the noise-receiving circuit may be added to the analysis target circuit model 200. For example, as shown in FIG. 9, the analysis target circuit model 200 may be generated, in which a power supply line model 6 and a substrate model 5 are respectively connected between the noise source model 3 and the package models 1, and a power supply line model 8 and a substrate model 7 are respectively connected between the noise-receiving circuit model 2 and the package models 1. The analysis target circuit model 200 is used for the circuit analysis. In the above configuration, the power supply line model 6 is a lumped constant circuit model generated on the basis of a power supply network from a pad to the noise source circuit in an analysis target circuit. similarly, the power supply line model 8 is a lumped constant circuit model generated on the basis of a power supply network from a pad to the noise-receiving circuit in the analysis target circuit. Also, the substrate model 5 is a lumped constant circuit model generated on the basis of a power supply network and a substrate network from a pad to the noise source circuit in the analysis target circuit. Similarly, the substrate model 7 is a lumped constant circuit model generated on the basis of a power supply network and a substrate network from the pad to the noise-receiving circuit in the analysis target circuit.

When the analysis target circuit model 200 shown in FIG. 9 is generated, the substrate model generating section 107 performs a circuit simulation on the basis of a parasitic element group (an RLC network) of power supply line between the pad and the noise source circuit, and uses a result of the simulation (input/output characteristics) to generate the lumped constant circuit model (the power supply line model 6). Similarly, the substrate model generating section 107 generates the power supply line model 8, which is a lumped constant circuit model, on the basis of the RLC network of power supply line between the pad and the noise-receiving circuit. Also, the substrate model generating section 107 performs a circuit simulation on the basis of GND line between the pad and the noise source circuit and a parasitic element group (an RLC network) of the silicon substrate, and uses the result of the simulation (input/output characteristics) to generate the lumped constant circuit model (the substrate model 5). Similarly, the substrate model generating section 107 generates the substrate model 7, which is a lumped constant circuit, on the basis of GND line between the pad and the noise-receiving circuit and an RLC network of the silicon substrate.

As described above, the analysis target circuit model 200 further including the power supply and substrate models between the pads and the noise source circuit and between the pads and the noise-receiving circuit is used to perform the circuit analysis, and thereby a more detailed analysis result can be obtained. It should be noted that even a circuit model in which from the analysis target circuit model 200 shown in FIG. 9, the power supply line model 5 and the substrate model 6 on a noise source side are removed, or a circuit model in which the power supply line model 7 and the substrate model 8 on a noise-receiving circuit side are removed, can be used as the analysis target circuit model. Alternatively, a circuit model added to the analysis target circuit model 200 shown in FIG. 9 may be used with being added to the analysis target circuit model 200 illustrated in FIG. 6.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A circuit analyzing method comprising:
generating an analysis object circuit model by connecting a package model as a lumped parameter circuit model of a package, a noise source model as a lumped parameter circuit model of a noise source circuit, a noise-receiving circuit model as a lumped parameter circuit model of a noise-receiving circuit, and a substrate model as a lumped parameter circuit model of a substrate between said noise source circuit and a noise-receiving circuit; and
performing a circuit simulation to said analysis object circuit model to calculate a power supply voltage waveform in said noise-receiving circuit.

2. The circuit analyzing method according to claim 1, further comprising:
generating said package model;
generating said noise source model;
generating said noise-receiving circuit model; and
generating said substrate model based on a parasitic device between said noise source circuit and said noise-receiving circuit.

3. The circuit analyzing method according to claim 2, wherein said generating said noise source model comprises:
specifying as said noise source circuit, a circuit block which generates power supply noise higher than a permissible value;
performing a circuit simulation by using a layout data of said specified noise source circuit to calculate input/output characteristics of said specified noise source circuit; and
calculating a lumped parameter circuit of said noise source circuit based on the input/output characteristics of said specified noise source circuit,
wherein a plurality of said noise source circuits are specified,
said generating said substrate model comprises:
generating said substrate model for each of said noise source circuits,
said generating said analysis object circuit model comprises:
generating said analysis object circuit model by connecting said package model, said noise source model, said noise-receiving circuit model, and said substrate model for each of said plurality of specified noise source circuits,
said performing circuit simulation comprises:
performing the circuit simulation to said analysis object circuit model for each of said plurality of specified noise source circuits to calculate the power supply voltage waveform in said noise-receiving circuit for the specified noise source circuit; and
synthesizing the power supply voltage waveforms for said plurality of specified noise source circuits.

4. The circuit analyzing method according to claim 2, wherein said generating said substrate model comprises:
extracting parasitic devices of a silicon substrate and a power supply line of said design object circuit based on the layout data of said design object circuit;
generating a RLC network of said power supply and said silicon substrate by using said parasitic device;
performing the circuit simulation based on said RLC network, the layout data of said noise source circuit and said noise-receiving circuit to generate a lumped parameter circuit model.

5. The circuit analyzing method according to claim 2, wherein said generating said RLC network comprises:
generating said RLC network based on said parasitic devices to power supply lines of two or more power supply systems between said noise source circuit and said noise-receiving circuit, and said parasitic device of said silicon substrate between said noise source circuit and said noise-receiving circuit.

6. The circuit analyzing method according to claim 2, wherein said generating said noise-receiving circuit model comprises:
specifying a circuit block in which a sensitivity to the power supply noise is higher than a threshold, as said noise-receiving circuit;
performing the circuit simulation by using the layout data of said specified noise-receiving circuit to generate the lumped parameter circuit model of said specified noise-receiving circuit.

7. The circuit analyzing method according to claim 1, further comprising:
performing the circuit simulation of said noise-receiving circuit by using said power supply voltage waveform and analyzing the operation characteristics of said noise-receiving circuit.

8. The circuit analyzing method according to claim 1, further comprising:
recording a magnitude of the power supply noise when said noise-receiving circuit operates without any problem, as a power supply noise permissible value; and
analyzing the operation characteristics of said noise-receiving circuit by comparing said power supply voltage waveform and said power supply noise permissible value.

9. A circuit analyzing apparatus comprising:
a storage section configured to store a package model as a lumped parameter circuit model of a package, a noise source model as a lumped parameter circuit model of a noise source circuit, a noise-receiving circuit model as a lumped parameter circuit model of a noise-receiving circuit, and a substrate model as a lumped parameter circuit model of a substrate between said noise source circuit and a noise-receiving circuit; and
a noise analyzing section configured connect said package model, said noise source model, said noise-receiving circuit model, and said substrate model to generate an analysis object circuit model.

10. The circuit analyzing apparatus according to claim 9, further comprising
a model generating section configured to generate said package model, said noise source model, said noise-receiving circuit model, and said substrate model based on parasitic devices between said noise source circuit and said noise-receiving circuit.

11. The circuit analyzing apparatus according to claim 9, further comprising:
a noise source specifying section configured to specify as said noise source circuit, a circuit block which generates power supply noise higher than a permissible value; and
a power supply voltage synthesizing section,
wherein said model generating section performs a circuit simulation by using a layout data of said specified noise source circuit to calculate input/output characteristics of said specified noise source circuit, and calculate a lumped parameter circuit of said noise source circuit based on the input/output characteristics of said specified noise source circuit,
wherein a plurality of said noise source circuits are specified,
said model generating section generates said substrate model for each of said specified noise source circuits,
said noise analyzing section generates said analysis object circuit model for each of said plurality of specified noise source circuits, performs the circuit simulation to said analysis object circuit model for each of said plurality of specified noise source circuits to calculate a power supply voltage waveform in said noise-receiving circuit for the specified noise source circuit, and
said power supply synthesizing section synthesizes the power supply voltage waveforms for said plurality of specified noise source circuits.

12. The circuit analyzing apparatus according to claim 10, further comprising:
a power supply & substrate extracting section configured to extract parasitic devices of a silicon substrate and a power supply line in said design object circuit based on a layout data of said design object circuit, and generates an RLC network of said power supply and said silicon substrate by using said parasitic device,
wherein said model generating section generates a lumped parameter circuit model based on said RLC network, the layout data of said noise source circuit and said noise-receiving circuit.

13. The circuit analyzing apparatus according to claim 12, wherein said RLC network comprises said parasitic devices to power supply lines of two or more power supply systems.

14. The circuit analyzing apparatus according to claim 10, further comprising:
a noise-receiving circuit specifying section configured to specify a circuit block in which sensitivity to the power supply noise is higher than a threshold, as said noise-receiving circuit,
wherein said model generating section performs the circuit simulation by using the layout data of said specified noise-receiving circuit to generate the lumped parameter circuit model of said specified noise-receiving circuit.

15. The circuit analyzing apparatus according to claims 11, further comprising:
a noise-receiving circuit simulation section configured to perform a circuit simulation of said noise-receiving circuit by using the power supply voltage waveform and analyze the operation characteristics of said noise-receiving circuit.

16. The circuit analyzing apparatus according to claim 11, further comprising:
a noise-receiving circuit simulation section,
wherein said storage section stores a magnitude of the power supply noise when said noise-receiving circuit operates without any problem, as a power supply noise permissible value, and
said noise-receiving circuit simulation section analyzes the operation characteristics of said noise-receiving circuit by comparing said power supply voltage waveform and said power supply noise permissible value.

17. A computer-readable recording medium in which a computer-executable program code is recorded for realizing a circuit analyzing method which comprises:
generating an analysis object circuit model by connecting a package model as a lumped parameter circuit model of a package, a noise source model as a lumped parameter circuit model of a noise source circuit, a noise-receiving circuit model as a lumped parameter circuit model of a noise-receiving circuit, and a substrate model as a lumped parameter circuit model of a substrate between said noise source circuit and a noise-receiving circuit; and
performing a circuit simulation to said analysis object circuit model to calculate a power supply voltage waveform in said noise-receiving circuit.

18. The recording medium according to claim 17, wherein said circuit analyzing method further comprises:
generating said package model;
generating said noise source model;
generating said noise-receiving circuit model; and
generating said substrate model based on a parasitic device between said noise source circuit and said noise-receiving circuit.

19. The recording medium according to claim 18, wherein said generating said noise source model comprises:
specifying as said noise source circuit, a circuit block which generates power supply noise higher than a permissible value;
performing a circuit simulation by using a layout data of said specified noise source circuit to calculate input/output characteristics of said specified noise source circuit; and
calculating a lumped parameter circuit of said noise source circuit based on the input/output characteristics of said specified noise source circuit,
wherein a plurality of said noise source circuits are specified,
said generating said substrate model comprises:
generating said substrate model for each of said noise source circuits,
said generating said analysis object circuit model comprises;
generating said analysis object circuit model by connecting said package model, said noise source model, said noise-receiving circuit model, and said substrate model for each of said plurality of specified noise source circuits,
said performing circuit simulation comprises:
performing the circuit simulation to said analysis object circuit model for each of said plurality of specified noise source circuits to calculate the power supply voltage waveform in said noise-receiving circuit for the specified noise source circuit; and
synthesizing the power supply voltage waveforms for said plurality of specified noise source circuits.

20. The recording medium according to claim 17, wherein the circuit analyzing method further comprises:
performing the circuit simulation of said noise-receiving circuit by using the power supply voltage waveform and analyzing the operation characteristics of said noise-receiving circuit.
